(19) United States
(12) Patent Application Publication
(10) Pub. No.: US 2026/0232001 A1
(43) Pub. Date: Aug. 13, 2026

(54) Food Cutting Device

(71) Applicant: Lyco Manufacturing, Inc., Columbus, WI (US)

(72) Inventors: Daniel D. Maupin, Corvallis, OR (US); Steven J. Schultz, Beaver Dam, WI (US); William D. Zittel, Columbus, WI (US); Jeffrey S. Zittel, Columbus, WI (US)

(21) Appl. No.: 19/467,414

(22) Filed: Feb. 2, 2026

Related U.S. Application Data
(60) Provisional application No. 63/758,043, filed on Feb. 13, 2025.

(51) Int. Cl. A23N 15/12

(52) U.S. Cl. CPC A23N 15/12

(57) ABSTRACT

A food preparation device including a cylinder defining multiple apertures and including multiple snipper knives is shown. In use, the snipper knives cut objects that extend through one of the apertures, such as ends of food items, such as string beans, that are moved through the cylinder during which time one or more ends of the string beans may be cut by the snipper knives.

### CROSS-REFERENCE TO RELATED PATENT APPLICATION

The present application claims the benefit of and priority to U.S. Provisional Application No. 63/758,043 filed on Feb. 13, 2025, which is incorporated herein by reference in its entirety.

### BACKGROUND OF THE INVENTION

The present invention relates generally to the field of food preparation. The present invention relates specifically to a snipper and snipper knives used for food processing to cut food items, such as elongate vegetables.

### SUMMARY OF THE INVENTION

One embodiment of the invention relates to a food preparation device including a cylinder, a plurality of couplers coupled to the outer wall of the cylinder, and a plurality of snipper knives each of which are coupled to a coupler of the plurality of couplers. The cylinder extends along a longitudinal axis between a first end and a second end. The cylinder is configured to receive a plurality of food items in the first end and that exit out the second end. The plurality of food items travel within the cylinder in a first direction that is generally parallel to the longitudinal axis. The cylinder includes an outer wall defining a first outer surface facing away from the longitudinal axis, the outer wall defining a plurality of apertures providing fluid communication between an interior of the cylinder and an exterior of the cylinder. The plurality of apertures are configured to receive a portion of each of a food item of the plurality of food items. Each of the plurality of snipper knives are biased against the outer surface of the cylinder by the respective coupler. Each of the plurality of snipper knives includes a body, the body defining a second outer surface facing away from the cylinder, a first end, a second end opposite the first end, a first cutting edge on a first side of the body, the first cutting edge extending between the first end and the second end, a second cutting edge on a second side of the body opposite the first side, an aperture defined by the body, the aperture located between the first end and the second end and between the first cutting edge and the second cutting edge, a first stiffening rib between the aperture and the second end, the first stiffening rib extending away from the cylinder and above the second outer surface of the body, and a second stiffening rib between the aperture and the first end, the second stiffening rib extending away from the cylinder and above the second outer surface of the body.

In various embodiments, for each of the snipper knives, the first end defines a first width and the second end defines a second width greater than the first width. In various embodiments, for each of the snipper knives the first stiffening rib is within 0.5″ of the aperture. In various embodiments, for each of the snipper knives the second stiffening rib is within 0.5″ of the aperture.

In various embodiments, each of the plurality of snipper knives includes a third stiffening rib between the aperture and the first cutting edge. The third stiffening rib extends away from the cylinder and above the second outer surface of the body. The third stiffening rib extends between the first stiffening rib and the second stiffening rib. In various embodiments, for each of the snipper knives the third stiffening rib is within 0.5″ of the aperture.

In various embodiments, each of the plurality of snipper knives includes a fourth stiffening rib between the aperture and the second cutting edge. The fourth stiffening rib extends away from the cylinder and above the second outer surface of the body. The fourth stiffening rib extends between the first stiffening rib and the second stiffening rib. In various embodiments, for each of the snipper knives the fourth stiffening rib is within 0.5″ of the aperture.

In various embodiments, for each of the snipper knives the first stiffening rib, the second stiffening rib, the third stiffening rib, and the fourth stiffening rib collectively circumferentially surround the entire aperture.

In various embodiments, for each of the snipper knives the body includes an inner surface that faces inward towards the aperture and that defines the aperture, wherein each of the first stiffening rib, the second stiffening rib, the third stiffening rib, and the fourth stiffening rib extend above and further away from the cylinder than the inner surface.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a food preparation device, according to an exemplary embodiment.

FIG. 2 is a side view of a portion of the food preparation device of FIG. 1, according to an exemplary embodiment.

FIG. 3 is perspective view of a snipper knife of the food preparation device of FIG. 2, according to an exemplary embodiment.

FIG. 4 is front view of a snipper knife of the food preparation device of FIG. 2, according to an exemplary embodiment.

FIG. 5 is cross-section view of the snipper knife of the food preparation device of FIG. 4 taken along line 5-5, according to an exemplary embodiment.

### DETAILED DESCRIPTION

Referring generally to the figures, various embodiments of a food processing device, and in particular a cutting device for use with a food processing device, are shown. During the processing of food items, such as elongate vegetables (e.g., green beans), the ends of the food items may be desired to be cut off from the rest of the food item. One way to accomplish this is to insert the food items through a cylinder that includes a plurality of apertures through which the ends of the food items extend as the food item traverses the cylinder. One or more snipper knives are attached to the cylinder to cut off the ends of the food items sticking through the apertures.

Applicant has observed that, in part due to the unique shape of snipper knives, the scrap rate is relatively high during manufacture and use generally, and in particular during manufacture of the snippers. For example, some geometries had an excessive scrap rate exceeding 10% for various geometric variations due to cylinder diameter of the food processing device from smaller to larger diameters. To strengthen and reduce the manufacturing variations of the snipper knife the Applicant has observed that adding a stiffening rib around one or more parts of an aperture in the snipper knife can lower the scrap rate of the snipper knives, such as during manufacture.

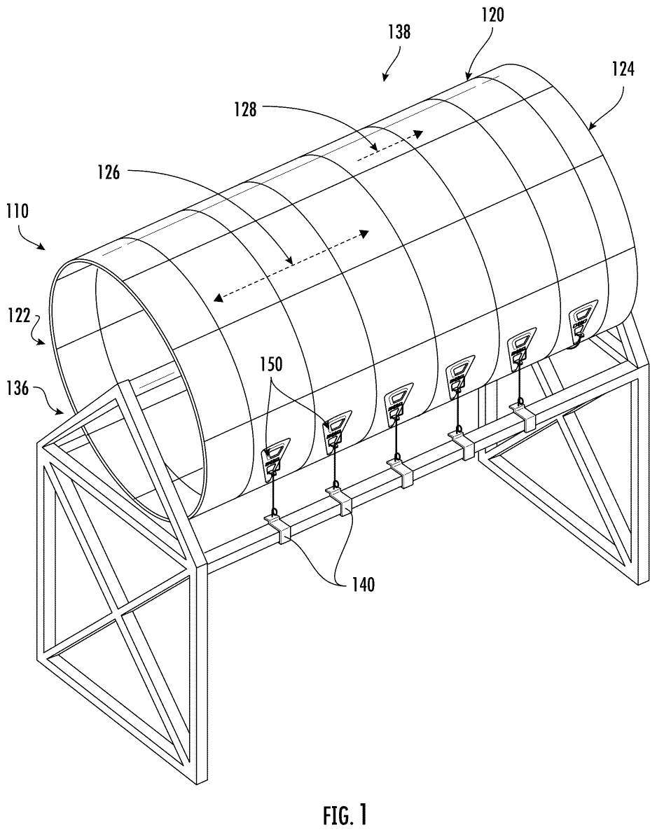

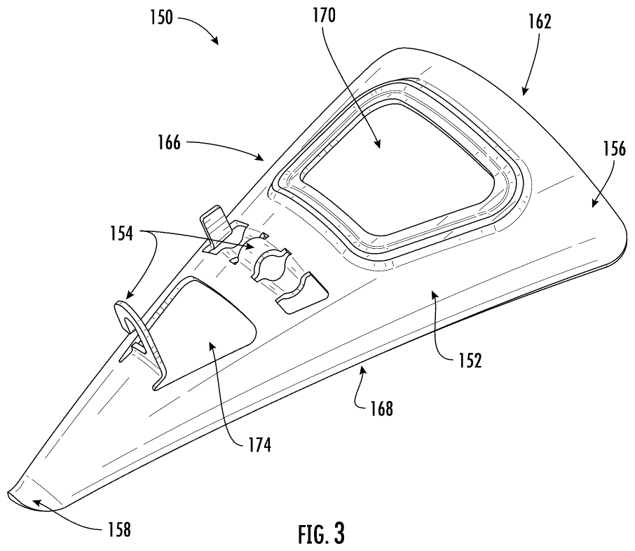

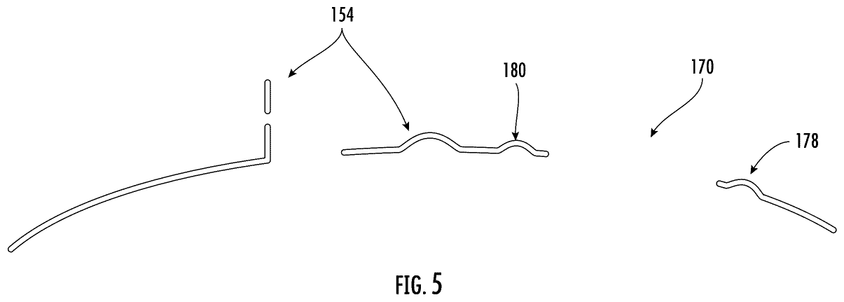

Referring to FIGS. 1-5, various aspects of food processing device 110 generally and snipper knives 150 in particular are shown. Food processing device 110 includes cylinder 120 extending along a longitudinal axis 126 between a first end 122 and a second end 124. Cylinder 120 is configured to receive a plurality of food items in the first end 122 and which exit the cylinder 120 via the second end 124, the plurality of food items travelling within the cylinder 120 in a first direction 128 that is generally parallel to the longitudinal axis 126. The cylinder 120 includes an outer wall 130 defining a first outer surface 132 facing away from the longitudinal axis 126. The outer wall 130 defines a plurality of openings 134 providing fluid communication between an interior 136 of the cylinder 120 and an exterior 138 of the cylinder 120.

The plurality of openings 134 are configured to receive a portion of each of a food item of the plurality of food items. For example, if the plurality of food items include beans, such as string beans, the ends of the string beans would tumble within cylinder 120 as cylinder is being rotated until one end of each string beans extends through one of the openings 134. At that point, one of the snipper knives 150 would cut the end of the string bean off, allowing the string bean to continue moving in direction 128 towards second end 124 of cylinder 120. In use, the majority and/or the vast majority are removed when the string beans exit cylinder 120.

Food preparation device 110 includes a plurality of snipper knives 150 biased against the first outer surface 132 of the cylinder 130. In various embodiments, each of the plurality of snipper knives 150 includes a body 152 defining a second outer surface 156 facing away from the cylinder 120, a first end 158, a second end 162 opposite the first end 158, a first cutting edge 166 on a first side 167 of the body 152, the first cutting edge 166 extending between the first end 158 and the second end 162, a second cutting edge 168 on a second side 169 of the body 152 opposite the first side 167, the second cutting edge 168 extending between the first end 158 and the second end 162, and an aperture 170 defined by the body 152, the aperture 170 located between the first end 158 and the second end 162 and between the first cutting edge 166 and the second cutting edge 168. In use, the snipper knives 150 move with respect to cylinder 120 (e.g., via oscillating) to result in cutting ends of the food items that extend through the openings 134.

In various embodiments, each of the plurality of snipper knives 150 includes a stiffening rib 178 (e.g., a first stiffening rib 178) between the aperture 170 and the second end 162, the first stiffening rib 178 extending above the second outer surface 156 of the body 152 and away from the cylinder 120.

In various embodiments, for each of the plurality of snipper knives 150 the first end 158 defines a first width 160 and the second end 162 defines a second width 164 greater than the first width 160. In various embodiments, for each of the plurality of snipper knives 150 the first stiffening rib 178 is within 0.5″ of the aperture 170. In various embodiments, the first stiffening rib 178 extends along an axis 179 that extends towards each of the first cutting edge 166 and the second cutting edge 168, such as the first axis 179 extending in an arcuate shape (e.g., concave from the perspective of the cylinder 120).

In various embodiments, each of the plurality of snipper knives 150 includes a second stiffening rib 180 between the aperture 270 and the first end 158, the second stiffening rib 180 extending above the second outer surface 156 of the body 152 and away from the cylinder 120. In various embodiments, for each of the plurality of snipper knives 150 the second stiffening rib 180 is within 0.5″ of the aperture 170. In various embodiments, the second stiffening rib 180 extends along an axis 181 that extends towards each of the first cutting edge 166 and the second cutting edge 168.

In various embodiments, each of the plurality of snipper knives includes a third stiffening rib 182 between the aperture 170 and the first cutting edge 166, the third stiffening rib 182 extending above the second outer surface 156 of the body 152 and away from the cylinder 120, and each of the plurality of snipper knives includes a fourth stiffening rib 184 between the aperture 170 and the second cutting edge 168, the fourth stiffening rib 184 extending above the second outer surface 156 of the body 152 and away from the cylinder 120. In various embodiments, for each of the plurality of snipper knives 150 the third stiffening rib 182 is within 0.5″ of the aperture 170 and the fourth stiffening rib 184 is within 0.5″ of the aperture 170.

In various embodiments, for each of the plurality of snipper knives 150 the first stiffening rib 178, the second stiffening rib 180, the third stiffening rib 182, and the fourth stiffening rib 184 collectively circumferentially surround the aperture 170. In various embodiments, for each of the plurality of snipper knives 150 the body 152 includes an inner surface 172 that faces inward towards the aperture 170 and that defines the aperture 170, and each of the first stiffening rib 178, the second stiffening rib 180, the third stiffening rib 182, and the fourth stiffening rib 184 extend above and further away from the cylinder 120 than the inner surface 172.

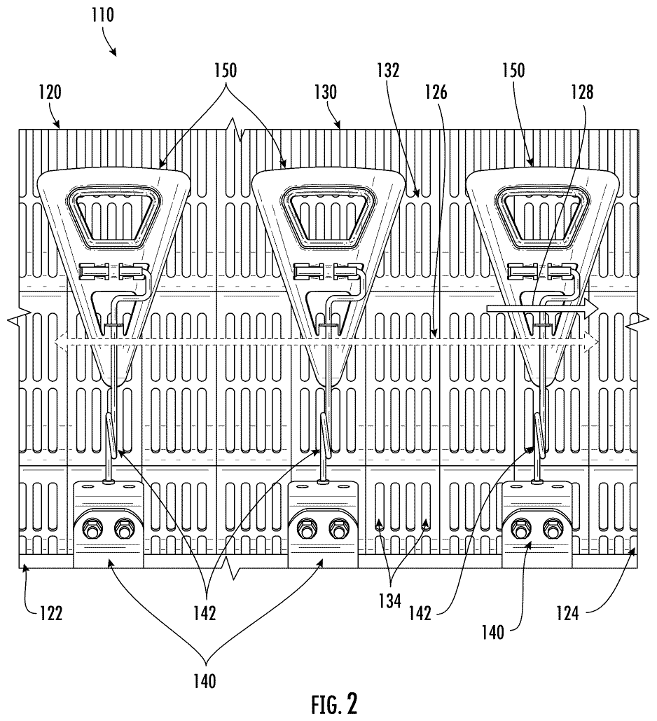

Referring to FIG. 2, food processing device 110 includes a cylinder 120 extending along longitudinal axis 126 from first end 122 to second end 124. Cylinder 120 is configured to receive a plurality of food items in the first end 122 and to expel the plurality of food items out the second end 124, such as via the cylinder 120 being tilted so that the second end 124 is lower than first end 122, thereby biasing the food items towards second end 124 as cylinder 120 is rotated.

A plurality of couplers 140 are coupled to an object (e.g., cylinder 120, such as to outer walls 130) and biased against cylinder 120. Each coupler 140 includes a biasing element, shown as spring 142.

Food processing device 110 includes a plurality of snipper knives 150 each of which are coupled to a coupler 140 of the plurality of couplers 140. Each of the plurality of snipper knives 150 are biased against the outer surface 132 of the outer wall 130 of cylinder 120 by the respective coupler 140, which is coupled to receiver 154 of snipper knife 150. In various embodiments, snipper knives 150 slide with respect to cylinder 120 in use, thereby resulting in snipper knives 150 cutting the food items that extend out of cylinder 120 (e.g., the ends of string beans).

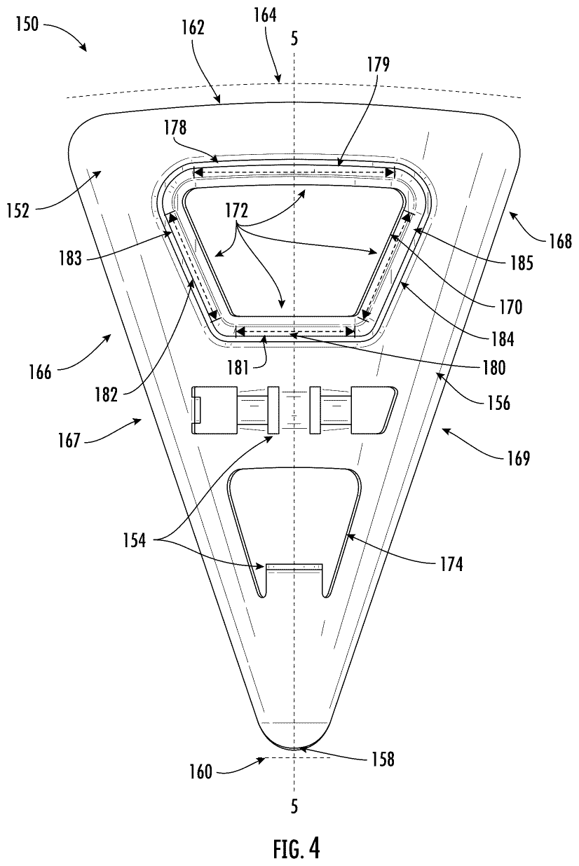

Each of the plurality of snipper knives 150 includes body 152, the body 152 defining a second outer surface 156 facing away from the cylinder 120, a first end 158, a second end 162 opposite the first end 158, a first cutting edge 166 on a first side of the body 152, the first cutting edge 166 extending between the first end 158 and the second end 162, and a second cutting edge 168 on a second side of the body 152 opposite the first side. First end 158 extends first width 160 and second end 162 extends second width 164, which is greater than first width 160. In various embodiments of snipper knife 150, second width 164 is far greater than first width 160 (e.g., more than two times, more than three times, more than five times, and more specifically more than ten times), and as a result snipper knife 150 has a generally triangular shape (see FIG. 4). The cutting edges are configured to cut off the ends of food items, such as vegetables, such as string beans.

Each of the snipper knives 150 further includes an aperture 170 defined by the body 152, the aperture 170 located between the first end 158 and the second end 162 and between the first cutting edge 166 and the second cutting edge 168. Each of the snipper knives 150 further includes a first stiffening rib 178 between the aperture 170 and the second end 162, the first stiffening rib 178 extending away from the cylinder 120 and above the second outer surface 156 of the body 152. Each of the snipper knives 150 further includes a second stiffening rib 180 between the aperture 170 and the first end 158, the second stiffening rib 180 extending away from the cylinder 120 and above the second outer surface 156 of the body 152.

Body 152 defines inner surface 172 that faces in and defines aperture 170. In various embodiments, aperture 170 is between receiver 154 and second end 162.

In various embodiments, each of the plurality of snipper knives 150 includes a third stiffening rib 182 between the aperture 170 and the first cutting edge 166. The third stiffening rib 182 extends away from the cylinder 120 and above the second outer surface 156 of the body 152. The third stiffening rib 182 extends between the first stiffening rib 178 and the second stiffening rib 180.

In various embodiments, each of the plurality of snipper knives 150 includes a fourth stiffening rib 184 between the aperture 170 and the second cutting edge 168. The fourth stiffening rib 184 extends away from the cylinder 120 and above the second outer surface 156 of the body 152. The fourth stiffening rib 184 extends between the first stiffening rib 178 and the second stiffening rib 180.

Applicant has observed that first stiffening rib 178 and/or second stiffening rib 180 and/or third stiffening rib 182 and/or fourth stiffening rib 184 provide structural support to body 152, thereby adding structural stability to the snipper knife 150.

In various embodiments, for each of the snipper knives 150 the first stiffening rib 178, the second stiffening rib 180, the third stiffening rib 182, and the fourth stiffening rib 184 collectively circumferentially surround the entire aperture 170.

In various embodiments, for each of the snipper knives 150 the body 152 includes an inner surface 172 that faces inward towards the aperture 170 and that defines the aperture 170. Each of the first stiffening rib 178, the second stiffening rib 180, the third stiffening rib 182, and the fourth stiffening rib 184 extend above and further away from the cylinder 120 than the inner surface 172.

In an alternative embodiment, one or more of the stiffening rib 178, 180, 182, 184 extend from the opposite side of the snipper knife 150 towards the cylinder 120.

In various embodiments, each of the first stiffening rib 178, the second stiffening rib 180, the third stiffening rib 182, and the fourth stiffening rib 184 are located within 0.5″ of the aperture 170.

In various embodiments, one or more of the snipper knives 150 includes a fifth stiffening rib extending from the outer surface 156 between aperture 174 and aperture 170.

In various embodiments, the snipper knives 150 are made from steel, such as a hardenable steel.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A food preparation device comprising;
a cylinder extending along a longitudinal axis between a first end and a second end, the cylinder configured to receive a plurality of food items in the first end and which exit the cylinder via the second end, the plurality of food items travelling within the cylinder in a first direction that is generally parallel to the longitudinal axis, the cylinder comprising an outer wall defining a first outer surface facing away from the longitudinal axis, the outer wall defining a plurality of openings providing fluid communication between an interior of the cylinder and an exterior of the cylinder, the plurality of openings configured to receive a portion of each of a food item of the plurality of food items; and
a plurality of snipper knives biased against the first outer surface of the cylinder, each of the plurality of snipper knives comprising:
a body defining a second outer surface facing away from the cylinder;
a first end;
a second end opposite the first end;
a first cutting edge on a first side of the body, the first cutting edge extending between the first end and the second end;
a second cutting edge on a second side of the body opposite the first side, the second cutting edge extending between the first end and the second end;
an aperture defined by the body, the aperture located between the first end and the second end and between the first cutting edge and the second cutting edge; and
a first stiffening rib between the aperture and the second end, the first stiffening rib extending above the second outer surface of the body and away from the cylinder.

2. The food preparation device of claim 1, for each of the plurality of snipper knives the first end defines a first width and the second end defines a second width greater than the first width.

3. The food preparation device of claim 1, for each of the plurality of snipper knives the first stiffening rib is within 0.5″ of the aperture.

4. The food preparation device of claim 1, wherein the first stiffening rib extends along an axis that extends towards each of the first cutting edge and the second cutting edge.

5. The food preparation device of claim 1, each of the plurality of snipper knives comprises a second stiffening rib between the aperture and the first end, the second stiffening rib extending above the second outer surface of the body and away from the cylinder.

6. The food preparation device of claim 5, for each of the plurality of snipper knives the second stiffening rib is within 0.5″ of the aperture.

7. The food preparation device of claim 5, wherein the second stiffening rib extends along an axis that extends towards each of the first cutting edge and the second cutting edge.

8. The food preparation device of claim 5, each of the plurality of snipper knives comprises:
a third stiffening rib between the aperture and the first cutting edge, the third stiffening rib extending above the second outer surface of the body and away from the cylinder; and
a fourth stiffening rib between the aperture and the second cutting edge, the fourth stiffening rib extending above the second outer surface of the body and away from the cylinder.

9. The food preparation device of claim 8, for each of the plurality of snipper knives the third stiffening rib is within 0.5″ of the aperture and the fourth stiffening rib is within 0.5″ of the aperture.

10. The food preparation device of claim 8, for each of the plurality of snipper knives the first stiffening rib, the second stiffening rib, the third stiffening rib, and the fourth stiffening rib collectively circumferentially surround the aperture.

11. The food preparation device of claim 8, for each of the plurality of snipper knives the body comprises an inner surface that faces inward towards the aperture and that defines the aperture, wherein each of the first stiffening rib, the second stiffening rib, the third stiffening rib, and the fourth stiffening rib extend above and further away from the cylinder than the inner surface.

12. A food preparation device comprising;
a cylinder extending along a longitudinal axis between a first end and a second end, the cylinder configured to receive a plurality of food items in the first end and which exit the cylinder via the second end, the plurality of food items travelling within the cylinder in a first direction that is generally parallel to the longitudinal axis, the cylinder comprising an outer wall defining a first outer surface facing away from the longitudinal axis, the outer wall defining a plurality of openings providing fluid communication between an interior of the cylinder and an exterior of the cylinder, the plurality of openings configured to receive a portion of each of a food item of the plurality of food items;
a plurality of snipper knives biased against the first outer surface of the cylinder, each of the plurality of snipper knives comprising:
a body defining a second outer surface facing away from the cylinder;
a first end;
a second end opposite the first end;
a first cutting edge on a first side of the body, the first cutting edge extending between the first end and the second end;
a second cutting edge on a second side of the body opposite the first side, the second cutting edge extending between the first end and the second end;
an aperture defined by the body, the aperture located between the first end and the second end and between the first cutting edge and the second cutting edge; and
a first stiffening rib between the aperture and the first end, the first stiffening rib extending above the second outer surface of the body and away from the cylinder.

13. The food preparation device of claim 12, for each of the plurality of snipper knives the first end defines a first width and the second end defines a second width greater than the first width.

14. The food preparation device of claim 12, for each of the plurality of snipper knives the first stiffening rib is within 0.5″ of the aperture.

15. The food preparation device of claim 12, wherein the first stiffening rib extends along an axis that extends towards each of the first cutting edge and the second cutting edge.

16. A food preparation device comprising;
a cylinder extending along a longitudinal axis between a first end and a second end, the cylinder configured to receive a plurality of food items in the first end and which exit the cylinder via the second end, the plurality of food items travelling within the cylinder in a first direction that is generally parallel to the longitudinal axis, the cylinder comprising an outer wall defining a first outer surface facing away from the longitudinal axis, the outer wall defining a plurality of openings providing fluid communication between an interior of the cylinder and an exterior of the cylinder, the plurality of openings configured to receive a portion of each of a food item of the plurality of food items;
a plurality of snipper knives biased against the first outer surface of the cylinder, each of the plurality of snipper knives comprising:
a body defining a second outer surface facing away from the cylinder;
a first end;
a second end opposite the first end;
a first cutting edge on a first side of the body, the first cutting edge extending between the first end and the second end;
a second cutting edge on a second side of the body opposite the first side, the second cutting edge extending between the first end and the second end;
an aperture defined by the body, the aperture located between the first end and the second end and between the first cutting edge and the second cutting edge;
a first stiffening rib between the aperture and the first cutting edge, the first stiffening rib extending above the second outer surface of the body and away from the cylinder; and
a second stiffening rib between the aperture and the second cutting edge, the second stiffening rib extending above the second outer surface of the body and away from the cylinder.

17. The food preparation device of claim 16, for each of the plurality of snipper knives the first end defines a first width and the second end defines a second width greater than the first width.

18. The food preparation device of claim 17, for each of the plurality of snipper knives the first stiffening rib is within 0.5″ of the aperture.

19. The food preparation device of claim 17, wherein the first stiffening rib extends along an axis that extends towards the first end.

20. The food preparation device of claim 19, wherein the second stiffening rib extends along an axis that extends towards the first end.
